(19) United States
(12) Patent Application Publication
(10) Pub. No.: US 2024/0207675 A1
(43) Pub. Date: Jun. 27, 2024

(54) MULTI-FUNCTIONAL ELECTRIC BICYCLE

(71) Applicant: Suijimanbu (Shanghai) Sports Technology CO., Ltd., Baoshan District (CN)

(72) Inventor: Qisong LIU, Baoshan District (CN)

(73) Assignee: Suijimanbu (Shanghai) Sports Technology CO., Ltd., Shanghai (CN)

(21) Appl. No.: 18/107,331

(22) Filed: Feb. 8, 2023

(30) Foreign Application Priority Data
Dec. 22, 2022 (CN) 202211655465.1

(51) Int. Cl. A63B 22/06; A63B 69/16

(52) U.S. Cl. CPC A63B 22/0605; A63B 69/16; A63B 2069/164; A63B 2071/0625

(57) ABSTRACT

A multi-functional electric bicycle is provided. The multi-functional electric bicycle includes: an electric bicycle body including a bicycle frame, a driving component, a linkage component, a pedal component, a sensor module and wheels; and a support component; wherein, in a case where the electric bicycle body is supported by the support component, the electric bicycle is in an indoor exercise state, and in a case where the electric bicycle body is supported by the wheels, the electric bicycle is in an outdoor riding state. The present disclosure can make the electric bicycle switch between indoor exercise state and outdoor riding state.

### CROSS-REFERENCE TO RELATED APPLICATIONS

This application is based upon and claims priority to Chinese Patent Application No. 202211655465.1, filed on Dec. 22, 2022, the entire contents of which are incorporated herein by reference.

### TECHNICAL FIELD

The present disclosure relates to an electric bicycle, and more particularly to a multi-functional electric bicycle.

### BACKGROUND

In order to save the power required by users for outdoor riding, an ordinary bicycle can be installed with a motor, a controller, a battery and so on to play the role of auxiliary energy, then the ordinary bicycle functions as an electric bicycle.

However, current electric bicycles can only be used for outdoor riding, and their functions are relatively simple.

Therefore, how to realize the multi-functional electric bicycle is a technical problem to be solved in the field.

### SUMMARY

According to one aspect of the present disclosure, there is provided a multi-functional electric bicycle, which comprises:
an electric bicycle body comprising a bicycle frame, a driving component, a linkage component, a pedal component, a sensor module and wheels; and
a support component;
wherein, in a case where the electric bicycle body is supported by the support component, the electric bicycle is in an indoor exercise state, and in a case where the electric bicycle body is supported by the wheels, the electric bicycle is in an outdoor riding state.

### BRIEF DESCRIPTION OF THE DRAWINGS

The foregoing and other features, and advantages of the present disclosure will become more apparent by describing the example embodiments thereof in detail with reference to the accompanying drawings:

FIG. 1 is a schematic diagram of a multi-functional bicycle according to an embodiment of the present invention;

FIG. 2 is a block diagram of a driving control signal generation module controlling a driving component according to an embodiment of the present invention;

FIG. 3 is a block diagram of a driving control signal generation module controlling a driving component according to another embodiment of the present invention;

FIG. 4 is a flowchart of controlling a device to execute an exercise mode in a case where a multi-functional bicycle is in an indoor exercise state according to embodiments of the present invention;

FIG. 5 is a display interface of a control device according to embodiments of the present invention;

FIG. 6 is a flowchart of generating a first exercise guiding video according to embodiments of the present invention;

FIG. 7 is a flowchart of a movement instruction sequence according to embodiments of the present invention;

FIG. 8 is a flowchart of generating a second exercise guiding video according to embodiments of the present invention;

FIG. 9 is a flowchart of generating a CGA with special-effect/animated feedbacks according to embodiments of the present invention;

FIG. 10 is a flowchart of exercise interaction feedback according to embodiments of the present invention;

FIG. 11 is a flowchart showing a ranking list display area according to embodiments of the present invention;

FIG. 12 shows a display interface of a control device with a ranking list display area according to embodiments of the present invention;

FIG. 13 is a flowchart of a control device providing the outdoor riding simulation function in a case where the multi-functional bicycle is in an indoor exercise state according to embodiments of the present invention;

FIG. 14 is an interface diagram of a virtual sports scene according to embodiments of the present invention;

FIG. 15 is a schematic diagram of a multi-functional electric bicycle according to another embodiment of the present invention;

FIG. 16 is a schematic diagram of a multi-functional electric bicycle according to yet another embodiment of the present invention.

### DETAILED DESCRIPTION

The example embodiments will now be described more fully with reference to the accompanying drawings. However, the example embodiments can be implemented in a variety of forms, and should not be construed as limited to the examples set forth herein; on the contrary, providing these embodiments will make the invention more comprehensive and complete, and comprehensively convey the idea of example embodiments to those skilled in the art. The described features, structures or characteristics may be combined in one or more embodiments in any suitable manner.

In addition, the accompanying drawings are only schematic diagrams of the invention and are not necessarily drawn to scale. The same reference numerals in the figures represent the same or similar parts, and therefore repeated description of them will be omitted. Some of the block diagrams shown in the drawings are functional entities and do not necessarily correspond to physically or logically independent entities. These functional entities may be implemented in software, or in one or more hardware modules or integrated circuits, or in different networks and/or processor devices and/or microcontroller devices.

The flow chart shown in the accompanying drawings is only an illustrative description and does not necessarily comprise all the steps. For example, some steps can also be decomposed, while others can be merged or partially merged. Therefore, the order of actual execution may change according to the actual situation.

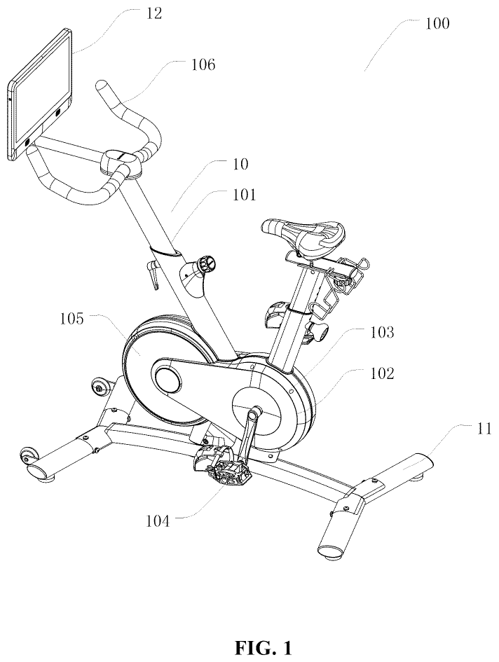

FIG. 1 is a schematic diagram of a multi-functional bicycle according to an embodiment of the present invention. As shown in FIG. 1, the multi-functional bicycle 100 comprises an electric bicycle body 10 and a support component 11.

The electric bicycle body 10 comprises a bicycle frame 101, a driving component 102, a linkage component 103, a pedal component 104, a sensor module and wheels 105.

The linkage component 103 connects the wheels 105 and the bicycle frame 101, and the pedal component 104 is connected to the wheels 105, so that the user can step on the pedal component 104 to rotate one of the two wheels 105, and drive to the other of the two wheels 105 through the linkage component 103. The linkage component 103 can be chain linkage or dead flight linkage. The electric bicycle provided in the present application is not limited by linkage modes.

The driving component 102 can be connected to the bicycle frame 101, the linkage component 103, the wheels 105 or other positions to facilitate auxiliary driving of the bicycle or provide riding resistance. This application is not limited by this. The sensor module can be set at one or more positions of the pedal component 104, the driving component 102, the wheel hubs of the wheels 105, the saddle set on the bicycle frame and the handles of the bicycle frame 101, so as to sense the user performance data such as the stepping frequency, resistance (stepping resistance), user's heart rate, and user's movement state during the exercise. The present application can also set different sensor modules at different positions to obtain more different types of user performance data, which will not be repeated here.

In a case where the electric bicycle body 10 is supported by the support component 11, the electric bicycle 100 is in an indoor exercise state, and in a case where the electric bicycle body 10 is supported by the wheels 105, the electric bicycle 100 is in an outdoor riding state. Therefore, the electric bicycle can be reused for outdoor riding and indoor exercise, without requiring users to purchase bicycle products for outdoor riding and indoor exercise respectively. Indoor exercise bikes usually set driving components to provide resistance, so that indoor exercise bikes can be reused in outdoor riding to provide auxiliary power outdoors.

In some embodiments, the support component 11 is a support bracket independent of the electric bicycle body 10. Therefore, the support component 11 can be placed indoors. In a case where the user carries the electric bicycle 100 outdoors, the electric bicycle body 10 of the electric bicycle 100 is supported by the wheels 105, so that the user can ride outdoors; in a case where the user moves the electric bicycle 100 indoors and the electric bicycle 100 is supported by the support component 11, the user can use the electric bicycle 100 for indoor exercise. Therefore, the user does not need to carry the support component 11 to reduce the outdoor riding load.

In other embodiments, the support component 11 is connected to the electric bicycle body 10 in a supporting state or is not connected to the electric bicycle body 10 in a non-supporting state. In this embodiment, whether indoors or outdoors, the support component 11 is connected to the electric bicycle body 10. In a case where the user wants to ride outdoors, the support component 11 can be adjusted so that the electric bicycle body 10 of the electric bicycle 100 is supported by the wheels 105; in a case where the user wants to exercise indoors, the support component 11 can be adjusted so that the electric bicycle body 10 of the electric bicycle 100 is supported by the support component 11. In this embodiment, the support component 11 can comprise a plurality of support parts to stably support the electric bicycle body 10 of the electric bicycle 100. Therefore, the user does not need to use the electric bicycle to exercise indoors at a fixed position (where the support component 11 is placed).

The above is only a schematic description of the support component of the present application, and the present application is not limited by the structure and installation position of the support component.

In some embodiments, in a case where the electric bicycle 100 is in an indoor exercise state, the driving component 102 provides resistance to the movement of the pedal component 104 of the electric bicycle body 10 to achieve exercise effects. Specifically, the resistance provided can be set according to different exercise requirements or adaptively adjusted. In a case where the electric bicycle 100 is in an outdoor riding state, the driving component 102 provides driving force to the movement of the pedal component 104 and/or the linkage component 103 of the electric bicycle body 10 to provide auxiliary power for users to ride outdoors.

Further, in a case where the electric bicycle 100 is in an indoor exercise state, the kinetic energy generated by the movement of the pedal component 104 of the electric bicycle body 10 can be converted into electric energy to charge the power unit of the driving component 102, so as to achieve the effect of energy conservation while the user exercises indoors.

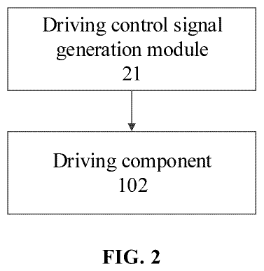

Referring to FIG. 2 below, which is a block diagram of a driving control signal generation module controlling a driving component according to an embodiment of the present invention. In this embodiment, the electric bicycle further comprises a driving control signal generation module 21. The driving control signal generation module 21 is configured to: generate a first signal in response to the electric bicycle being in an indoor exercise state; generate a second signal in response to the electric bicycle being in an outdoor riding state; and send the first signal or the second signal that are generated to the driving component 102. In a case where the driving component 102 receives the first signal, the driving component 102 provides resistance to the movement of the pedal component of the electric bicycle body. In a case where the driving component 102 receives the second signal, the driving component 102 provides driving force to the movement of the pedal component and/or the linkage component of the electric bicycle body. Thus, the driving component 102 can be controlled by different signals that are generated by the driving control signal generation module 21.

For the driving control signal generation module 21, the present application can provide a variety of different signal generation methods.

In some embodiments, the driving control signal generation module 21 is further configured to determine that the electric bicycle is in an indoor exercise state or an outdoor riding state in response to user operations. For example, the driving control signal generation module 21 has a switch control, which determines that the electric bicycle is in an indoor exercise state or an outdoor riding state in response to the user's operation on the switch control. The driving control signal generation module 21 can generate the first signal or the second signal according to the switch position of the switch control, and send them to the driving component 102 for control. The driving control signal generation module 21 and its switch control are easy to implement and have low implementation cost.

In some embodiments, the driving control signal generation module 21 can also generate the first signal or the second signal according to the location information of the electric bicycle. The location information can be obtained from the location module set on the electric bicycle. After obtaining the location information, the location information can be matched with the preset indoor position range. In response to the electric bicycle being located within the preset indoor position range, the driving control signal generation module 21 generates the first signal; in response to the electric bicycle being located outside the preset indoor position range, the driving control signal generation module 21 generates the second signal. The location information can also be obtained based on the short distance communication (such as Bluetooth, infrared, radio frequency identification, LAN, ZigBee and other short distance wireless communication technologies) between the communication module on the electric bicycle and the indoor communication module. For example, in a case where the communication module on the electric bicycle can communicate with the indoor communication module, the location information indicates that the electric bicycle is located indoors, and the driving control signal generation module 21 generates the first signal; in a case where the communication module on the electric bicycle cannot communicate with the indoor communication module, the location information indicates that the electric bicycle is not located indoors, and the driving control signal generation module 21 generates the second signal. The accuracy of generating the first signal/the second signal can be improved by the location information.

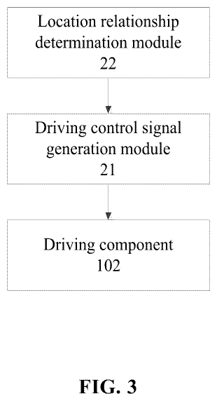

In some embodiments, the multi-functional electric bicycle can further comprise a location relationship determination module 22. Referring to FIG. 3, FIG. 3 is a block diagram of a driving control signal generation module controlling a driving component according to another embodiment of the present invention.

The location relationship determination module 22 is configured to determine the location relationship between the electric bicycle body and the support component. Correspondingly, the driving control signal generation module 21 is further configured to determine that the electric bicycle is in an indoor exercise state or an outdoor riding state according to the location relationship between the electric bicycle body and the support component. For example, the location relationship determination module 22 may comprise a first sensing component set on the electric bicycle body and a second sensing component set on the support component. In a case where the first sensing component and the second sensing component are inductively matched, the support component supports the electric bicycle body, the location relationship determination module 22 determines that the electric bicycle is in an indoor exercise state, and the driving control signal generation module 21 generates the first signal; in a case where the first sensing component and the second sensing component are not inductively matched, the support component does not support the electric bicycle body, the location relationship determination module 22 determines that the electric bicycle is in an outdoor riding state, and the driving control signal generation module 21 generates the second signal. The present application is not limited by this. For another example, the electric bicycle body and the support component can be connected with a bump and a card slot, and the location relationship determination module 22 may comprise a signal generator and a signal receiver arranged on two sides of the inner wall of the card slot. When the bump is clamped with the card slot, the signal from the signal generator is interrupted by the bump and cannot be received by the signal receiver sensor, so the location relationship determination module 22 can know that the electric bicycle body and the support component are clamped, the electric bicycle is in an indoor exercise state, and the driving control signal generation module 21 generates the first signal; in a case where the bump is not clamped with the card slot, the signal sent by the signal generator is transmitted to the signal receiver sensor, so that the location relationship determination module 22 can know that the electric bicycle body and the support component are not clamped, the electric bicycle is in an outdoor riding state, and the driving control signal generation module 21 generates the second signal. The location relationship determination module 22 can also be implemented in other ways, and the present application is not limited by this. The accuracy of generating the first signal/second signal can be improved by the location relationship determination module 22.

In some embodiments, the sensor module is configured to sense user performance data, and the sensor module communicates with the control device. In a case where the multi-functional electric bicycle is in the indoor exercise state, the control device is configured to receive the user performance data from the sensor module, and process the user performance data through the application program of the control device to provide indoor exercise interaction functions and/or outdoor riding simulation functions; and/or real-time detection of the users' movement states, action, and postures. Therefore, the present application can provide a variety of different riding functions even indoors through the processing and feedback of the user performance data.

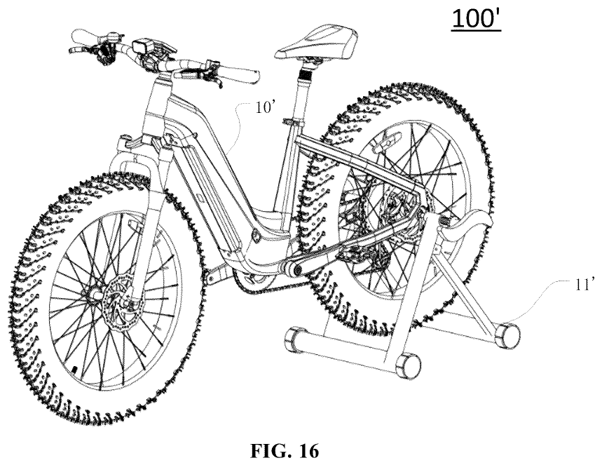

In some embodiments, as shown in FIG. 16, the multi-functional electric bicycle 100′ (comprising the electric bicycle body 10′ and the support component 11′) may not be equipped with a display screen, so that the control device is the user intelligent device independent of the multi-functional electric bicycle. The user intelligent device may comprise, for example, but are not limited to, mobile phones, tablet computers, and smart televisions. Specifically, the user intelligent device may install relevant application programs and communicate with the sensor module through wireless connection to obtain the user performance data sensed by the sensor module. The user intelligent device may process the user performance data by itself or send the user performance data to the server for processing, so as to provide the indoor exercise interaction function and/or the outdoor riding simulation function.

In the above embodiments, in a case where the user intelligent device is a portable intelligent device (such as a mobile phone) and the multi-functional electric bicycle is in the outdoor riding state, the control device may also communicate with the sensor module, so that the outdoor riding data can be generated and displayed based on the user performance data received from the sensor module. In this embodiment, the user can monitor the outdoor riding state, and can also obtain information such as riding route, riding speed, riding road conditions, etc. by combining the location function of the portable intelligent device itself and the user performance data. Therefore, the user intelligent device can not only provide the indoor exercise interaction function and/or the outdoor riding simulation function when it is in indoor riding state, but also generate and display outdoor riding data based on the user performance data received from the sensor module, so as to realize the recording, processing and feedback of the user performance data during the whole indoor and outdoor process.

In other embodiments, the control device is detachably arranged on the handle end of the bicycle frame 11, such as the control device 12 shown in FIG. 1. The control device 12 may be a display with data processing function, which plays audio and video towards the bicycle frame 11. In some variations, the control device 12 may also be a projector with data processing function, which projects video and plays audio against the bicycle frame 11. The control device 12 may provide the user with an operation interface to facilitate the user to perform music selection, video selection, exercise course selection, volume adjustment, etc. on the contents displayed by the control device 12 through voice, touch, gesture, etc. The present invention is not limited by this. Specifically, the control device 12 may install related application programs and communicate with the sensor module through wireless connection to obtain user performance data sensed by the sensor module. The control device 12 may process the user performance data by itself or send the user performance data to the server for processing, so as to provide the indoor exercise interaction function and/or the outdoor riding simulation function.

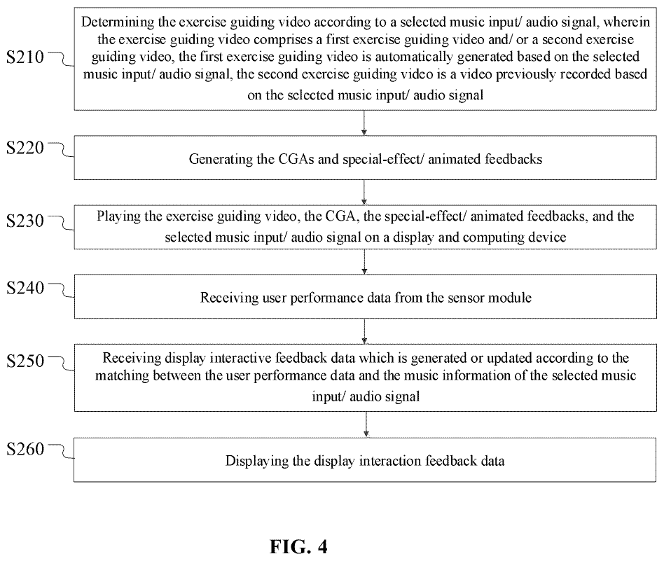

Specifically, in a case where the application programs of the control device provide the indoor exercise interaction function, it can be configured to execute the steps shown in FIG. 4:

S210: determining the exercise guiding video according to a selected music input/audio signal, wherein the exercise guiding video comprises a first exercise guiding video and/or a second exercise guiding video, the first exercise guiding video is automatically generated based on the selected music input/audio signal, the second exercise guiding video is a video previously recorded based on the selected music input/audio signal.

Specifically, the music input/audio signal is selected according to a user selection. For example, the user can select a music file in a provided music library as the selected music input/audio signal. For another example, the user can upload a local music file as the selected music input/audio signal. For another example, the user can upload a hyperlink of a third-party music file, from which the server can obtain the music input/audio signal and related information.

Specifically, the music information are stored in the music library with music information. The local music file uploaded by the user can be analyzed by the server/control device to extract the music information. The music information may comprise music attributes/features and rhythm feature sequences. The rhythm feature sequences may comprise multiple rhythm feature segments. The rhythm feature sequences may further comprise bpm (beats per minute). Each rhythm feature segment may comprise the time of each beat of the rhythm feature segment in the music input/audio signal and the duration of the rhythm feature segment. In some specific embodiments, each rhythm feature segment may comprise eight beats, which is not the limitation of the invention. The rhythm feature sequences may further comprise, for example, a downbeat time series comprising the time of each downbeat in the music input/audio signal. The music attributes/features may comprise one or more of a variety of measurements or quantification of music energy, music duration, music segments, lyrics, genre, and artist. Specifically, the music input/audio signal can be separated into a plurality of music segments according to lyrics sentences, lyrics paragraphs, etc., and the division of music segments can be used as the data information of music segments. A variety of measurements or quantification of music energy can be the audio intensity change data between different rhythm feature segments/different music segments. The above is only a schematic description of the music information provided by the present invention, which is not the limitation of the invention.

Specifically, the selected music input/audio signal is determined based on the matching between a user portrait and the music information of the music input/audio signal. The user portrait can be obtained by learning from the user's basic data and/or the user's exercise course data. The user's basic data may comprise height, age, gender, weight, etc. of the user. The user's exercise course data may comprise a class level, movement preference, aesthetic style preference, etc. of the user. The movement preference can be obtained by learning from the number of movements performed and the degree of movement completion in the user's exercise course data. The aesthetic style preference of the user can be obtained by learning from the number of CGAs and special-effect/animated feedbacks used in the user's exercise course data, as well as the feedback of the user performance data when playing the CGA and special-effect/animated feedbacks. Furthermore, a matching model can be used to obtain the matching relationship between the user portrait and the music information of the music input/audio signal. For example, a plurality of user portraits can be used as the input of the matching model, and the music information of the music input/audio signal can be used as the output of the matching model to train the matching model. The trained matching model can be used to match the user portraits and the music information of the music input/audio signal. The present invention can realize other matching methods, for example, multiple preferred music input/audio signal (as user portraits) can be obtained by acquiring the song list of the user's music application, the playing times of each music input/audio signal, etc. to match with the music input/audio signal in the music library. The matching methods of these changes are within the protection scope of the present invention.

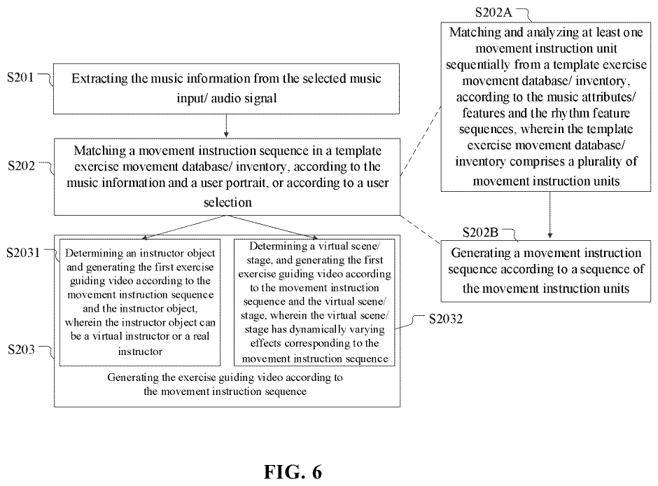

Specifically, the real-time generation and pre-recording of the exercise guiding video will be described in detail in combination with FIG. 6 to FIG. 8, and will not be repeated here.

S220: generating the CGAs and special-effect/animated feedbacks.

In the embodiment, the CGA is used for a background of the exercise guiding video. The CGA can be a static image or a dynamic animation. The CGA can be used to represent a virtual scene/stage or extended reality. For example, the extended reality can be a sea scene, a forest scene, a city scene, or a stage, etc. The virtual scene/stage can be a sea scene, a forest scene, a city scene, or a stage, etc., built of a plurality of elements. In other embodiments, the CGA can also be a background having solid color background or alphabet-inspired background.

Specifically, the special-effect/animated feedbacks can be virtual light effects overlaid and integrated on the CGA. The special-effect/animated feedbacks can also be special processing effects to elements in the CGA (for example, image scaling, making the element move/feedback in synchronization with the beats/rhythm, etc.). The present invention is not limited by this.

In some embodiments, the CGA and the special-effect/animated feedbacks can be matched according to the user portrait. For example, the CGA and the special-effect/animated feedbacks are matched and analyzed to the user's aesthetic style preference in the user portrait. In some other embodiments, the CGA and the special-effect/animated feedbacks are matched according to the music information. For example, the CGA and the special-effect/animated feedbacks are matched and analyzed to the music segments, lyrics, genre. In an embodiment, the CGA and the special-effect/animated feedbacks can be labeled, and a model comprising mapping relations between the music information and the labels is previously built. Then the matching and analyzing between the CGA and the special-effect/animated feedbacks and the music information can be realized using the model. In another embodiment, the CGA and the special-effect/animated feedbacks can be matched and analyzed to the user portrait and the music information. In the embodiment, a first score is obtained by matching and analyzing the CGA and the special-effect/animated feedbacks to the user portrait, and a second score is obtained by matching and analyzing the CGA and the special-effect/animated feedbacks to the music information. A total score is obtained by weighted summation of the first score and the second score, and the CGA and the special-effect/animated feedbacks are selected according to the total score.

S230: playing the exercise guiding video, the CGA, the special-effect/animated feedbacks, and the selected music input/audio signal on a display and computing device.

Specifically, when playing the exercise guiding video, the CGA, the special-effect/animated feedbacks, and the selected music input/audio signal on the control device, the synthesis steps of the exercise guiding video, the CGA, the special-effect/animated feedbacks, and the selected music input/audio signal can be performed, so that the control device plays the synthesized audio and video files.

S240: receiving user performance data from the sensor module.

Specifically, when providing the indoor exercise interaction function, the control device can receive the user performance data from the sensor module, and the user performance data can comprise stepping frequency, resistance, user heart rate, whether the user is in a sitting position, and so on.

S250: receiving display interactive feedback data which is generated or updated according to the matching between the user performance data and the music information of the selected music input/audio signal.

S260: displaying the display interaction feedback data.

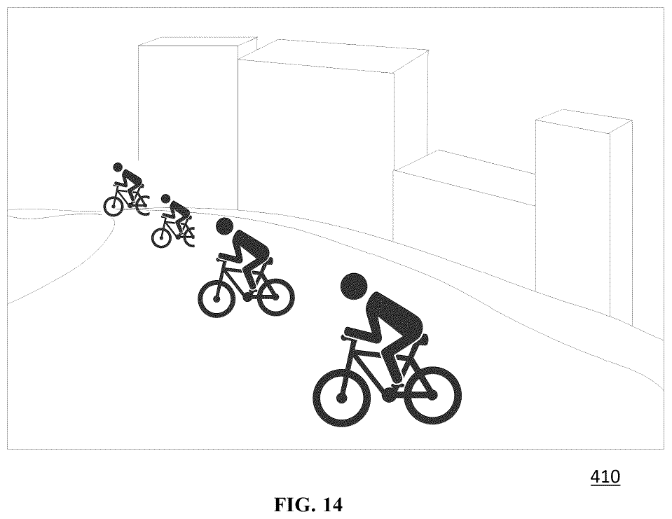

Further, in some embodiments, virtual sports scenes constructed by modeling software/engine determined from the selected music input/audio signal can also be received and played, so that interactive feedback can be made based on virtual sports scenes and received user performance data. Virtual sports scenes can comprise maps, cities, outdoors in real worlds, or sports scenes created from pure virtual worlds. This application is not limited by this. The virtual sports scene may refer to the interface 410 shown in FIG. 14. FIG. 14 is only illustrative, and this application is not limited by this.

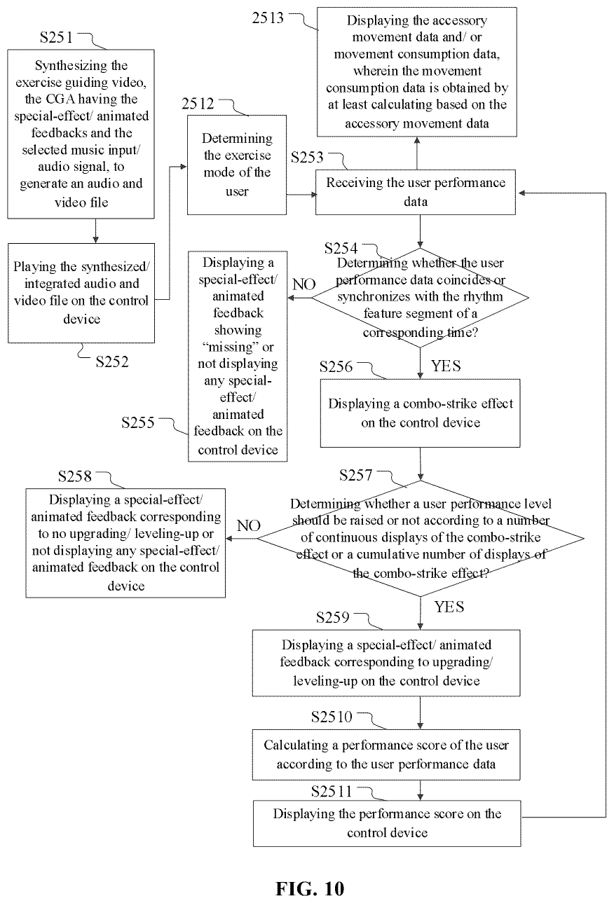

In the embodiment, the interactive feedback data provided can comprise whether the user performance data match to the beat or other audio signals, whether combo-strike is achieved (determined according to the matching result of the user movements with the beat or other audio signals), a number of combo-strikes, a user performance level, a user performance score, user exercise data, etc., which are determined by the matching result of the user performance data and the music information of the music input/audio signal. The interactive feedback data will be described in detail by combining FIG. 10 to FIG. 12.

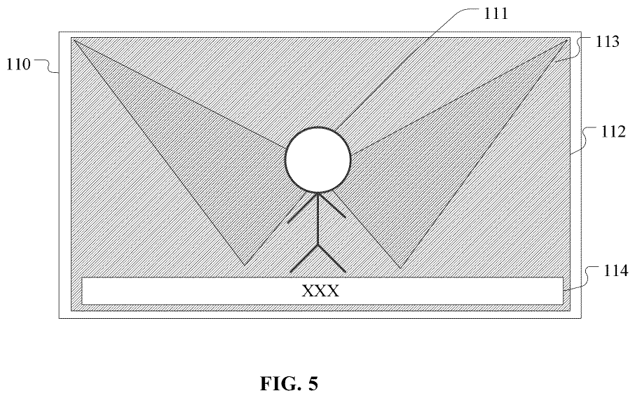

FIG. 5 is a schematic view of a display interface of a control device according to an embodiment of the present disclosure. As shown in FIG. 5, the interface displayed by the display screen 110 of the control device comprises a CGA 112, special-effect/animated feedbacks 113, an exercise guiding video 111 comprising an instructor object, and an interactive feedback area 114. FIG. 5 only schematically illustrates a kind of interface provided in the present disclosure. In other embodiments, the interface can be different from that shown in FIG. 5.

In the exercise interactive function, live/streamed videos with multiple layers of visual effects for guiding the user exercise can be provided to the user by playing the exercise guiding video, the CGA, the special-effect/animated feedbacks, and the interactive feedback data in an integrated/multi-layered way. By generating the exercise guiding video according to the music input/audio signal, and generating the interactive feedback data according to the matching and analyzing result between the music file and the user performance data, the exercise process of the user can be guided by the music input/audio signal, the entertainment benefit and the interactive experience during the user exercise are improved.

FIG. 6 is a flow chart of generating a first exercise guiding video according to an embodiment of the present disclosure. As shown in FIG. 6, the first exercise guiding video is generated by the following steps.

S201: extracting the music information from the selected music input/audio signal.

In the embodiment, the music information can comprise rhythm feature sequences. In some embodiments, the rhythm feature sequences can be extracted by a trained model. In another embodiment, the rhythm feature sequences can be extracted by processing the audio data of the selected music input/audio signal. In the embodiment, the rhythm feature sequences can be obtained by: identifying the beats from the selected music input/audio signal, obtaining the time of each beat in the selected music input/audio signal, separating the beats of the selected music input/audio signal into a plurality of rhythm feature segments, and sequencing the plurality of rhythm feature segments by time to get the rhythm feature sequences according to the preset number of beats contained in each rhythm feature segment. Furthermore, bpm (beats per minute) can also be calculated according to the number of beats per minute identified in the selected music input/audio signal.

In the embodiment, the music information of the selected music input/audio signal can comprise music attributes/features. The music attributes/features can comprise music duration, lyrics, genre, and artist, etc. The music duration, lyrics, genre, and artist can be stored with a mapping relationship to the selected music input/audio signal; therefore, this information can be obtained directly according to the selected music input/audio signal. The music attributes/features can comprise music segments. Specifically, the music input/audio signal can be separated into a plurality of music segments according to lyrics sentences, lyrics paragraphs, etc., and the division of music segments can be used as the data information of music segments. The music attributes/features may also comprise a variety of measurements or quantification of music energy. Specifically, a variety of measurements or quantification of music energy can be the audio intensity change data between different rhythm feature segments/different music segments. Therefore, a variety of measurements or quantification of music energy can be obtained according to the processing of the audio signal of the selected music input/audio signal.

S202: matching a movement instruction sequence in a template exercise movement database/inventory, according to the music information and a user portrait, or according to a user selection.

In the embodiment, the template exercise movement database/inventory comprises a plurality of movement instruction units. The movement data can be stored in the template exercise movement database/inventory according to the movement instruction units. The movement data can comprise a two-dimensional or three-dimensional movement model/mechanism. For example, the skeleton points, skeleton feature vectors, angles between the skeleton feature vectors, etc., are stored as objects of the movement instruction units. Position, moving track, moving speed of the objects of the movement instruction units are stored as the movement attribute features of the objects of the movement instruction units.

In the embodiment, according to the contents contained in the music information of the aforementioned selected music input/audio signal, step S202 can further comprise: step S202A: matching and analyzing at least one movement instruction unit sequentially from a template exercise movement database/inventory, according to the music attributes/features (such as beats per minutes, musical structure, music energy, rhythmic segmentation, etc.) and the rhythm feature sequences, wherein the template exercise movement database/inventory comprises a plurality of movement instruction units; and step S202B: generating a movement instruction sequence according to a sequence of the movement instruction units. In the embodiment, the details of step S202 will be described in the following by combining FIG. 6.

S203: generating the exercise guiding video according to the movement instruction sequence.

In the embodiment, the exercise guiding video generated in S203 is the first exercise guiding video. Step S203 can comprise step S2031: determining an instructor object and generating the first exercise guiding video according to the movement instruction sequence and the instructor object, wherein the instructor object can be a virtual instructor or a real instructor. In the embodiment, the virtual instructor can be a virtual instructor figure or an animated figure. The virtual instructor can be stored together with mapping relationships to figure data configured for building movements. The figure data can comprise virtual figure display data (for example, muscles, skins, etc.) based on the skeleton points, skeleton feature vectors, angles between the skeleton feature vectors, etc. Therefore, the virtual figure display data can be generated by matching and analyzing the data of each movement instruction unit in the movement instruction sequence to the stored virtual figure display data and synthesizing the data of each movement instruction unit with the matched virtual figure display data. In the embodiments, the real instructor can record content videos of the movement instruction units according to the template exercise movement database/inventory. Therefore, the first exercise guiding video can be generated by matching and analyzing the movement instruction sequence to the content video of each movement instruction unit previously recorded by the selected real instructor.

Furthermore, the instructor object can be determined according to a user selection. In other embodiments, the instructor object can also be determined according to the music information of the music input/audio signal and/or the user portrait. For example, user-preferred instructor objects can be determined according to historical exercise class data of the user. For another example, a user-preferred label of the instructor object can be determined according to the historical exercise class data of the user, and the instructor object can be determined by matching and analyzing the user-preferred label of the instructor object to the stored labels of the instructor objects. For another embodiment, a model can be used to learn the relationships between the music information of the music input/audio signals and the instructor objects, to realize the matching and analyzing between the music information of the music input/audio signals and the instructor objects by the model. Wherein the music information of the music input/audio signals can comprise only a part of the music attributes/features, for example, the genre, artist, lyrics, etc., to increase the efficiency of training and using the model. For another example, the instructor object can be determined by matching and analyzing the instructor objects to the music information and the user portrait.

Step S203 can further comprise step 2032: determining a virtual scene/stage or extended reality generated by CGA, and generating the first exercise guiding video according to the movement instruction sequence and the virtual scene/stage or extended reality, wherein the virtual scene/stage or extended reality has dynamically varying effects corresponding to the movement instruction sequence to improve engagement and immersiveness. In the embodiment, the virtual scene/stage or extended reality generated by CGA uses a scene or stage to show the movement instruction sequence, which is different from the aforementioned front layer using a form of an instructor object showing the movement instruction sequence. The virtual scene/stage or extended reality can be in the form of characters, graphics, etc., and the virtual scene/stage or extended reality has dynamically varying effects corresponding to the movement instruction sequence to improve engagement and immersiveness to show the movement instruction sequence.

Furthermore, the virtual scene/stage or extended reality generated by CGA can be selected by the user. In other embodiments, the virtual scene/stage or extended reality generated by CGA can also be determined according to the music information of the music input/audio signal and/or the user portrait. For example, user-preferred virtual scene/stage or extended reality generated by CGA can be determined according to the historical exercise class data of the user. For another example, a user-preferred label of the virtual scene/stage or extended reality generated by CGA can be determined according to the historical exercise class data of the user, and the virtual scene/stage or extended reality generated by CGA can be determined by matching and analyzing the user-preferred label of the virtual scene/stage or extended reality generated by CGA to the stored labels of the virtual scenes/stages or extended reality generated by CGA. For another embodiment, a model can be used to learn the mapping relationships between the music information of the music input/audio signals and the virtual scene/stage or extended reality generated by CGA, to realize the matching and analyzing between the music information of the music input/audio signals and the virtual scene/stage or extended reality by the model. Wherein the music information of the music input/audio signals can comprise only a part of the music attributes/features, for example, the genre, artist, lyrics, etc., to increase the efficiency of training and using the model. For another example, the virtual scene/stage or extended reality generated by CGA can be determined by matching and analyzing the virtual scenes/stages or extended reality generated by CGA to the music information and the user portrait.

In the embodiment, while generating the first exercise guiding video according to the movement instruction sequence, a preset rule can be used to adjust the video to make the transition between the movement instruction units smoother.

In some embodiments, a virtual sports scene can also be generated through the following steps: extracting the music information of the selected music input/audio signal; matching and analyzing the movement instruction sequence in the template exercise movement database/inventory, according to the music information and the user portrait, or according to the user selection; according to the movement instruction sequence, generating the exercise guiding video or the virtual sports scene. The virtual sports scene can be the same or different from the virtual scene/stage. In some embodiments, the virtual sports scene and the virtual scene/stage can both be maps, cities, outdoors in real world, or sports scenes created from the pure virtual world. In other embodiments, the virtual scene/stage may only be used as a background scene, while the virtual sports scene is used for user immersive motion.

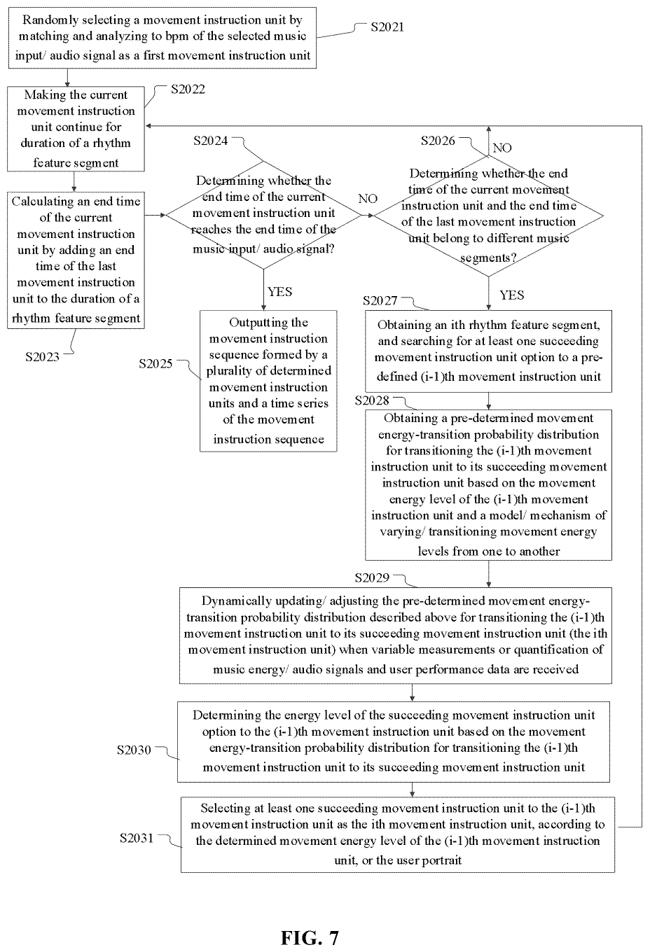

FIG. 7 is a flow chart of generating the movement instruction sequence. As shown in FIG. 7, the movement instruction sequence is generated by the following steps:

S2021: randomly selecting a movement instruction unit by matching and analyzing to bpm (beats per minute) of the selected music input/audio signal as a first movement instruction unit.

In the embodiment, each movement instruction unit can be stored with a mapping relationship to the corresponding bpm (beats per minute).

S2022: making the current movement instruction unit continue for duration of a rhythm feature segment.

For example, a movement duration of the current movement instruction unit is two beats, the duration of a rhythm feature segment is eight beats. So, the current movement instruction unit is repeated four times to continue for the duration of a rhythm feature segment.

S2023: calculating an end time of the current movement instruction unit by adding an end time of the last movement instruction unit to the duration of a rhythm feature segment.

S2024: determining whether the end time of the current movement instruction unit reaches the end time of the music input/audio signal.

If the end time of the current movement instruction unit reaches the end time of the music input/audio signal, the matching and analyzing of all the rhythm feature segments of the selected music input/audio signal have been completed, then step S2025 is executed, outputting the movement instruction sequence formed by a plurality of determined movement instruction units and a time series of the movement instruction sequence.

If the end time of the current movement instruction unit hasn't reached the total duration of the music input/audio signal, step S2026 is executed, determining whether the end time of the current movement instruction unit and the end time of the last movement instruction unit belong to different music segments.

If the end time of the current movement instruction unit and the end time of the last movement instruction unit belong to different music segments, step S2022 is executed again.

In the embodiment, step S2026 can be omitted according to different exercise requirements and exercise movements. For example, the number of exercise movements using the electric bicycle is less than other exercise modes, each movement instruction unit is made to continue for the duration of each music segment. When the music segment changes, steps S2027 to S2031 are executed to determine the subsequent movement instruction unit again. For another example, the number of exercise movements using the exercise accessory is more than other exercise modes, step S2026 can be omitted, to make the movement instruction unit only continue for the duration of a rhythm feature segment.

After step 2026, if the end time of the current movement instruction unit and the end time of the last movement instruction unit belong to a same music segment, then step S2027 is executed, obtaining an ith rhythm feature segment, and searching for at least one succeeding movement instruction unit option to a pre-defined (i−1)th movement instruction unit.

In the embodiment, i is an integer ranging from 2 to N, and Nis a number of the rhythm feature segments in the rhythm feature sequences. Wherein an initial value of i is 2, and every time the following step S2031 is executed, i=i+1.

In an embodiment, transition problems exist between different movement instruction units. Therefore, each movement instruction unit is related to a plurality of succeeding movement instruction unit options.

S2028: obtaining a pre-determined movement energy-transition probability distribution for transitioning the (i−1)th movement instruction unit to its succeeding movement instruction unit (the ith movement instruction unit) based on the movement energy level of the (i−1)th movement instruction unit and a model/mechanism of varying/transitioning movement energy levels from one to another.

In the embodiment, the movement energy level of each movement instruction unit is a preset movement intensity. A high-intensity movement instruction unit succeeding to another high-intensity movement instruction unit may cause excessive exercise intensity for the user, and may cause sports injuries to the user. A low-intensity movement instruction unit succeeding to another low-intensity movement instruction unit may cause insufficient movement intensity for the user, and expected exercise effects could not be achieved. In the embodiment, the model/mechanism of varying/transitioning movement energy levels from one to another can be obtained by learning the energy level varying measurements or quantification between the movement instruction units from historical exercise data. For example, the historical exercise data can be historical exercise class data. Sample data can be obtained by separating the movement instruction units in the historical exercise class data and determining the energy levels of the movement instruction units in the historical exercise class data. Then the model/mechanism of varying/transitioning movement energy levels from one to another can be trained using the sample data. The model/mechanism of varying/transitioning movement energy levels from one to another can provide a basic and general method of varying/transitioning movement energy levels from one to another. In step S2028, the movement energy level of the (i−1)th movement instruction unit can be input to the model/mechanism of varying/transitioning movement energy levels from one to another to obtain the pre-determined movement energy-transition probability distribution for transitioning the (i−1)th movement instruction unit to its succeeding movement instruction unit (the ith movement instruction unit). For example, the probability distribution of the movement energy level of transitioning the (i−1)th movement instruction unit to a first movement instruction unit option is a %, the probability distribution of the movement energy level of transitioning the (i−1)th movement instruction unit to a second movement instruction unit option is b %, and the probability distribution of the movement energy level of transitioning the (i−1)th movement instruction unit to a third movement instruction unit option is c %.

S2029: dynamically updating/adjusting the pre-determined movement energy-transition probability distribution described above for transitioning the (i−1)th movement instruction unit to its succeeding movement instruction unit (the ith movement instruction unit) when variable measurements or quantification of music energy/audio signals and user performance data are received.

In the embodiment, by step S2029, the pre-determined movement energy-transition probability distribution described above for transitioning the (i−1)th movement instruction unit to its succeeding movement instruction unit (the ith movement instruction unit) are further updated/adjusted according to a variety of measurements or quantification of music energy and the user performance data, based on the basic and general movement energy-transition probability distribution provided by the model/mechanism of varying/transitioning movement energy levels from one to another.

In the embodiment, the user performance data can comprise user live performance data or user performance data in a recent time period. Therefore, the user performance data can be used for determining whether the user can adapt to the model/mechanism of varying/transitioning movement energy levels from one to another. If yes, there is no need to adjust the obtained pre-determined movement energy-transition probability distribution. If no, it is determined that whether the user can complete the movement easily (for example, the user has a low heart rate during exercise) or the user feels hard to complete the movement (for example, the user has a high heart rate during exercise). If the user can complete the movement easily, probabilities of high energy levels can be raised and probabilities of low energy levels can be decreased in the movement energy-transition probability distribution. If the user feels hard to complete the movement, the probabilities of high energy levels can be decreased and the probabilities of low energy levels can be raised in the movement energy-transition probability distribution.

In the embodiment, a variety of measurements or quantification of music energy can be used for representing the varying measurements or quantification of the audio intensity. In general, when the audio intensity of the music input/audio signal is higher, the energy level of the current movement is higher; when the audio intensity of the music input/audio signal is lower, the energy level of the current movement is lower. Therefore, the music input/audio signal and the movements can be tightly combined. In the embodiment, if an energy level of the current music segment/rhythm feature segment is higher than an energy level of the last music segment/rhythm feature segment, probabilities of energy levels of the succeeding movement instruction unit option to the last movement instruction unit higher than the energy level of the last movement instruction unit can be raised, probabilities of energy levels of the succeeding movement instruction unit option to the last movement instruction unit lower than the energy level of the last movement instruction unit can be decreased. If the energy level of the current music segment/rhythm feature segment is lower than the energy level of the last music segment/rhythm feature segment, the probabilities of energy levels of the succeeding movement instruction unit option to the last movement instruction unit higher than the energy level of the last movement instruction unit can be decreased, probabilities of energy levels of the succeeding movement instruction unit option to the last movement instruction unit lower than the energy level of the last movement instruction unit can be raised. If the energy level of the current music segment/rhythm feature segment is equal to the energy level of the last music segment/rhythm feature segment, there is no need to adjust the pre-determined movement energy-transition probability distribution.

The above two adjustment methods can be implemented independently or in combination, which is not the limitation of the present invention.

S2030: determining the energy level of the succeeding movement instruction unit option to the (i−1)th movement instruction unit based on the movement energy-transition probability distribution for transitioning the (i−1)th movement instruction unit to its succeeding movement instruction unit (the ith movement instruction unit).

In the embodiment, an energy level having the highest probability can be determined to be the movement energy level of the succeeding movement instruction unit option to the (i−1)th movement instruction unit.

S2031: selecting at least one succeeding movement instruction unit to the (i−1)th movement instruction unit as the ith movement instruction unit, according to the determined movement energy level of the (i−1)th movement instruction unit, or the user portrait.

In some embodiments, a movement instruction unit can be determined as the ith movement instruction unit, by selecting from at least one succeeding movement instruction unit option of the (i−1)th movement instruction unit according to the determined movement energy level. In other embodiments, the movement instruction unit can be selected by the user as the ith movement instruction unit, from at least one succeeding movement instruction unit option of the (i−1)th movement instruction unit according to the determined movement energy level. In other embodiments, the movement instruction unit can be determined as the ith movement instruction unit, by selecting from at least one succeeding movement instruction unit option of the (i−1)th movement instruction unit according to the determined movement energy level and the user portrait. Wherein the user portrait comprises the user's preferred movements, which can be stored in the form of a preferred movement set. Therefore, the ith movement instruction unit can be determined by matching and analyzing the preferred movement set with at least one succeeding movement instruction unit.

After step S2031 is executed, step S2022 is executed again.

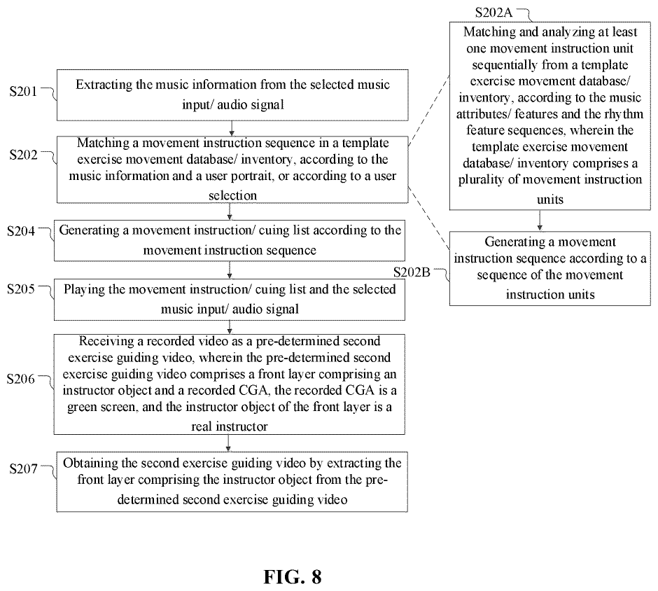

FIG. 8 is a flow chart of generating a second exercise guiding video according to an embodiment of the present disclosure. As shown in FIG. 8, the second exercise guiding video is generated by the following steps.

S201: extracting the music information of the selected music input/audio signal.

S202: generating a movement instruction sequence automatically by matching and analyzing movements in a template exercise movement database/inventory, according to the music information and a user portrait, or according to a user selection.

In the embodiment, step S202 can further comprise: step S202A: matching and analyzing at least one movement instruction unit sequentially from a template exercise movement database/inventory, according to the music attributes/features and the rhythm feature sequences; and step S202B: generating a movement instruction sequence according to a sequence of the movement instruction units, the details of step S202 will be referred to the aforementioned description by combining FIG. 6.

S204: generating a movement instruction/cuing list according to the movement instruction sequence.

In the embodiment, the movement instruction/cuing list is used to show the movement instruction sequence to be recorded. In some embodiments, the movement instruction/cuing list can be the first exercise guiding video generated by the steps shown in FIG. 5. In other embodiments, the movement instruction/cuing list can show the movement data (stored in the template exercise movement database/inventory) of each movement instruction unit of the movement instruction sequence. In some other embodiments, the movement instruction/cuing list can show a cue in text form.

S205: playing the movement instruction/cuing list and the selected music input/audio signal.

In the embodiment, the movement instruction/cuing list and the selected music input/audio signal are synchronized in a time sequence. Therefore, the movement instruction/cuing list and the selected music input/audio signal synchronized in time sequence can be played for the instructor so that the instructor can record a pre-determined second exercise guiding video under the guidance of the movement instruction/cuing list and the selected music input/audio signal. Furthermore, the time sequence of the music cue file can be set ahead of the selected music input/audio signal for a preset time. The instructor has enough time to understand the movement cue after seeing the movement cue video. Therefore, the movements performed by the instructor according to the movement instruction/cuing list can be synchronized with the selected music input/audio signal in the time sequence.

S206: receiving a recorded video as a pre-determined second exercise guiding video, wherein the pre-determined second exercise guiding video comprises a front layer comprising an instructor object and a recorded CGA, the recorded CGA is a green screen, and the instructor object of the front layer is a real instructor.

S207: obtaining the second exercise guiding video by extracting the front layer comprising the instructor object from the pre-determined second exercise guiding video.

In the embodiment, the second exercise guiding video is recorded using a green screen to facilitate the removal of the green screen. Therefore, the green screen can be easily removed from the pre-determined second exercise guiding video to extract the front layer comprising the instructor object, to generate the second exercise guiding video.

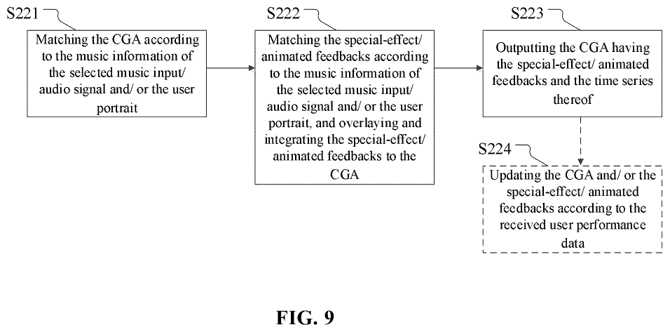

FIG. 9 is a flow chart of generating a CGA comprising special-effect/animated feedbacks according to an embodiment of the present disclosure. As shown in FIG. 9, the CGA is by the following steps:

S221: matching the CGA according to the music information of the selected music input/audio signal and/or the user portrait.

In the embodiment, the CGA can be selected from a CGA library, according to one or more of the music genres, the aesthetic style preference (preferred CGA style) in the user portrait, and the style requirement to the CGA of a class/community marketing activity. In the embodiment, each CGA is stored in the CGA library with a mapping relationship to a style label. Therefore, the CGA can be selected and determined by matching and analyzing the style label.

S222: matching the special-effect/animated feedbacks according to the music information of the selected music input/audio signal and/or the user portrait, and overlaying and integrating the special-effect/animated feedbacks to the CGA.

For example, the special-effect/animated feedbacks can be light effects, particle effects, etc. In the embodiment, the special-effect/animated feedbacks can be selected from a special-effect/animated library, according to the aesthetic style preference (preferred CGA style) of the user and/or the music genre. Furthermore, the varying of the special-effect/animated feedback can be determined according to the rhythm feature sequences of the music input/audio signal (comprising a beat time series and a downbeat time series), music segments, a variety of measurements or quantification of music energy. For example, the light effects can flash following the beats in the beat time series. The brightness of the light effect can be increased at the timing and location of the downbeat in the downbeat time series. The brightness can vary following a variety of measurements or quantification of music energy. For example, when the music energy of the current music segment/rhythmic feature segment is greater, the brightness of the light effect is greater; when the music energy of the current music segment/rhythmic feature segment is smaller, the brightness of the light effect is smaller.

Therefore, the determined special-effect/animated feedbacks and the method of changing the special-effect/animated feedbacks can be overlaid and integrated to the CGA.

S223: outputting the CGA having the special-effect/animated feedbacks and the time series thereof.

S224: updating the CGA and/or the special-effect/animated feedbacks according to the received user performance data.

In some embodiments, step S224 can be omitted. Therefore, the CGA and the special-effect/animated feedbacks obtained from step S223 can be output. In other embodiments, step S224 is executed to improve the interactive experience of the user. For example, when the user performance data shows that the current movement intensity is excessive for the user, the CGA and/or the special-effect/animated feedbacks can be adjusted to more smoothing CGA and/or special-effect/animated feedbacks, to help the user to alleviate exercise fatigue. For example, when the user performance data shows that the user is not exerting full effort during current exercise, the CGA and/or the special-effect/animated feedbacks can be adjusted to more striking CGA and/or special-effect/animated feedbacks to urge the user to exercise.

FIG. 10 is a flow chart of providing interactive feedback according to an embodiment of the present disclosure. As shown in FIG. 10, the interactive feedback is provided by the following steps.

S251: synthesizing the exercise guiding video, the CGA having the special-effect/animated feedbacks and the selected music input/audio signal, to generate an audio and video file.

S252: playing the synthesized/integrated audio and video file on the control device.

S2512: determining the exercise mode of the user.

In an embodiment only having one exercise mode, step S2512 can be omitted.

In the embodiment, the exercise modes comprise an electric bicycle mode, an exercise accessory mode, and a computer vision mode.

S253: receiving the user performance data.

S254: determining whether the user performance data coincides or synchronizes with the rhythm feature segment of a corresponding time.

If the user performance data doesn't coincide or synchronize with the rhythm feature segment of a corresponding time, step S255 is executed, displaying a special-effect/animated feedback showing “missing” or not displaying any special-effect/animated feedback on the control device.

If the user performance data coincides or synchronizes with the rhythm feature segment of a corresponding time, step S256 is executed, displaying a combo-strike effect on the control device.

S257: determining whether a user performance level should be raised or not according to a number of continuous displays of the combo-strike effect or a cumulative number of displays of the combo-strike effect.

If the user performance level shouldn't be raised, step S258 is executed, displaying a special-effect/animated feedback corresponding to no upgrading/leveling-up or not displaying any special-effect/animated feedback on the control device.

If the user performance level should be upgraded, step S259 is executed, displaying a special-effect/animated feedback corresponding to upgrading/leveling-up on the control device.

In the embodiment, steps S257-S259 are executed to inspire the user by displaying the special-effect/animated feedback corresponding to upgrading/leveling-up. The user performance level can represent the current exercise amount/movement intensity. The user performance level can be obtained by calculating a number of continuous displays of the combo-strike effect or a cumulative number of displays of the combo-strike effect. For example, when the number of continuous displays of the combo-strike effect is greater than a preset threshold, the user performance level should be upgraded. For another example, when the cumulative number of displays of the combo-strike effect is greater than a preset threshold, the user performance level should be upgraded/leveled up. When the cumulative number of displays of the combo-strike effect minus the cumulative number of displays of the combo-strike effect before the last time upgrade is greater than a preset threshold, the user performance level should be upgraded. Other varying modes can also be used in other embodiments of the present disclosure. In some embodiments, steps S257-S259 can also be omitted.

S2510: calculating a performance score of the user according to the user performance data.

In the embodiment, in step S2510, a unit score of the current movement instruction unit performed by the user can be firstly calculated, then the performance score of the user can be obtained by accumulating the unit score of the previous movement instruction units.

In an embodiment using the electric bicycle, the unit score can be calculated based on the resistance of the user performance data.

In the embodiment, when step S2510 is executed, the current movement instruction unit of the user is matched and analyzed to the music information of the music input/audio signal. That is to say, when step S2510 is executed, the current movement instruction unit is completed by the user, and a basic unit score can be obtained. The unit performance score can be calculated based on the basic unit score and the resistance of the user performance data. For example, a weight coefficient is calculated according to the resistance of the user performance data, and the unit score can be obtained by multiplying the weight coefficient and the basic unit score. The weight coefficient is positively related to the resistance of the user performance data. In other embodiments, the performance score can be obtained in other ways.

S2511: displaying the performance score on the control device.

Wherein, after step S253, step S2513 is executed, displaying the accessory movement data and/or movement consumption data, wherein the movement consumption data is obtained by at least calculating based on the accessory movement data. The accessory movement data comprises one or more of heart rate, movement duration, movement intensity.

In some embodiments, the control device communicates with other control devices to interact in different forms, such as racing, in the exercise guiding video or virtual sports scene based on the user performance data received by each control device.

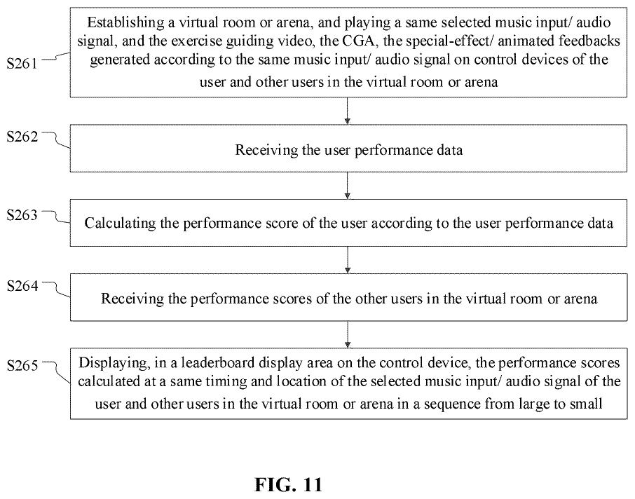

FIG. 11 is a flow chart of displaying a leaderboard display area according to an embodiment of the present disclosure. As shown in FIG. 11, the leaderboard display area is displayed by the following steps.

S261: establishing a virtual room or arena, and playing a same selected music input/audio signal, and the exercise guiding video, the CGA, the special-effect/animated feedbacks generated according to the same music input/audio signal on control devices of the user and other users in the virtual room or arena.

In the embodiment, a user can send, via the control device, an invitation of establishing a virtual room or arena to the control devices of other users. When at least one user receives the invitation and sends feedback data, the communication channel between the control devices of the users in the virtual room or arena is built.

In an alternative embodiment, in the virtual room or arena, the control devices of the users play the same content. In some embodiments, in the virtual room or arena, the control devices of the user and other users in the virtual room or arena play the same selected music input/audio signal, and the exercise guiding video, the CGA, the special-effect/animated feedbacks generated according to the same music input/audio signal.

S262: receiving the user performance data.

S263: calculating the performance score of the user according to the user performance data.

S264: receiving the performance scores of the other users in the virtual room or arena.

S265: displaying, in a leaderboard display area on the control device, the performance scores calculated at a same timing and location of the selected music input/audio signal of the user and other users in the virtual room or arena in a sequence from large to small. Wherein the displayed performance scores comprise the performance scores of the other users in the same virtual room or arena with the user at a same timing and location of the selected music input/audio signal.

In the embodiments, the control devices of the other users in a same virtual room or arena play a same selected music input/audio signal at the same time with the control device of the user. The live performance scores of the other users in the same virtual room or arena can be received, so that the displayed performance scores comprise the performance scores of the other users in the same virtual room or arena with the user at a same timing and location of the selected music input/audio signal.

In another embodiment, the control devices of the other users in the same virtual room or arena don't have to play the same selected music input/audio signal at the same time with the control device of the user. Displaying the performance scores calculated at a same timing and location of the selected music input/audio signal of the user and other users in the virtual room or arena can be realized by receiving the performance scores of the other users calculated at the current timing and location of the selected music input/audio signal played by the user. In other words, the performance scores of the user at various timing and locations of the selected music input/audio signal can be stored. Therefore, other users can receive the scores for display.

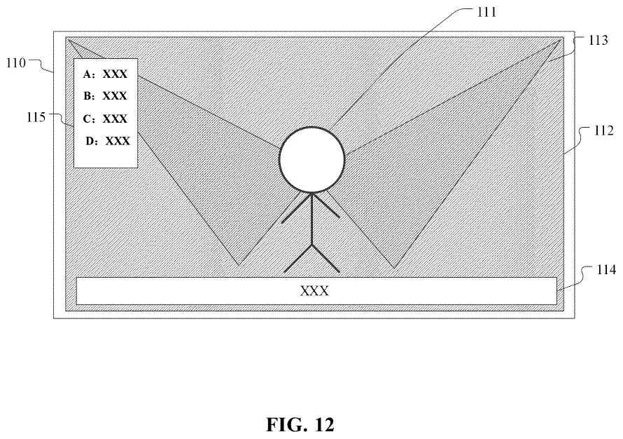

As shown in FIG. 12, the display screen of the control device 110 comprises CGA 112, special-effect/animated feedbacks 113, exercise guiding video 111 comprising an instructor object, an interactive feedback area 114, and a leaderboard display area 115. The leaderboard display area 115 can show user accounts and/or avatars of the users, and corresponding performance scores. The sequence of the performance scores displayed in the leaderboard display area 115 dynamically varies following the varying of the performance scores. FIG. 12 only schematically illustrates a kind of display interface provided by the present disclosure. In other embodiments, the display interface can be different from that shown in FIG. 12.

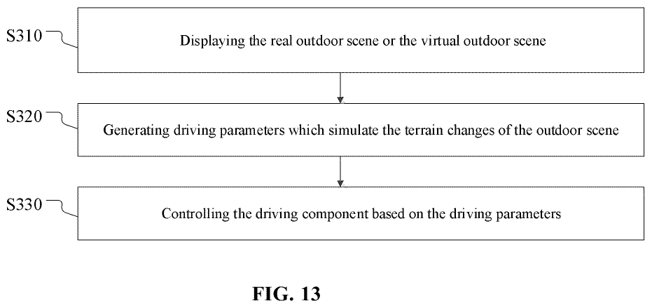

In some embodiments, the control device communicates with the driving component. In a case where the control device provides the outdoor riding simulation function, it is configured to perform the steps shown in FIG. 13:

S310: displaying the real outdoor scene or the virtual outdoor scene.

In some embodiments, the video of the displayed real or virtual outdoor scene can be provided by the server. In other embodiments, the displayed outdoor scene can be recorded by the user through the user intelligent device. For example, the user can fix the user intelligent device on the handle end of the bicycle frame when riding outdoors, so that the user intelligent device can record the user's outdoor riding scenes.

S320: generating driving parameters which simulate the terrain changes of the outdoor scene.

In some embodiments, in a case where the outdoor scene is provided by the server, the server can associate the outdoor scene to store the terrain changes of each road in the outdoor scene. In other embodiments, in a case where the outdoor scene is recorded by the user himself, the user intelligent device can upload the recorded video to the server to identify the terrain in the video by the server, so as to obtain the terrain changes of each road in the outdoor scene in the video.

Further, S320 can obtain the driving parameters of the driving component based on the above terrain changes. For example, in a case where the terrain changes to downhill, the driving parameters can be adjusted to reduce the resistance provided by the driving component; in a case where the terrain changes to uphill, the driving parameters can be adjusted to increase the resistance provided by the driving component. The present application can realize more changes, which will not be repeated here.

S330: controlling the driving component based on the driving parameters.

Specifically, the outdoor riding simulation function provides users with the interaction simulation of outdoor riding, so that the displayed real or virtual outdoor scene can be updated based on the user performance data received from the sensor module. For example, the user's riding speed can be determined according to the user performance data received from the sensor module, so as to determine the virtual position of the user in the real or virtual outdoor scene based on the user's speed, and adjust the displayed real or virtual outdoor scene according to the virtual position of the user. Furthermore, it is also possible to determine the user's riding direction in combination with the handle direction of the electric bicycle, determine the user's uphill/downhill position and the user's riding speed according to the current terrain changes to determine the user's virtual position in the real or virtual outdoor scene, and adjust the displayed real or virtual outdoor scene according to the user's virtual position.

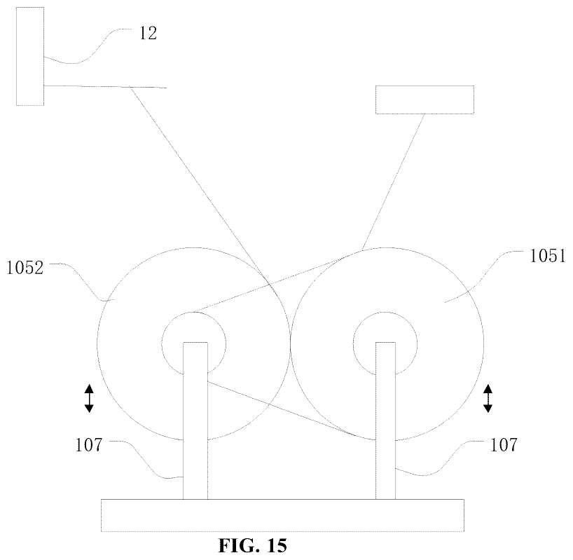

In some embodiments, the driving component further comprises a terrain simulation component, which is connected to the multi-functional electric bicycle when the multi-functional electric bicycle is in the indoor riding state to simulate the terrain changes of the outdoor scene. As shown in FIG. 15, FIG. 15 shows a schematic diagram of a multi-functional bicycle according to another embodiment of the present invention. In this embodiment, the terrain simulation component can be a lifting component 107 which is respectively arranged on the front wheel 1051 and the rear wheel 1052. Therefore, the lifting component 107 can simulate terrain changes such as uphill, downhill, and turbulence by lifting the front wheel 1051 and/or the rear wheel 1052. In some variations, the terrain simulation component can further comprise a steering component set at the front wheel 1051 to assist the front wheel 1051 in steering to simulate the steering of the electric bicycle indoors. The above is only a schematic description of the terrain simulation component provided in the present application, and the present application is not limited by this.

Therefore, the above embodiments can provide users with an indoor simulation experience of outdoor riding, so that users can have more indoor riding modes.

In some embodiments, the driving component of the electric bicycle can also be controlled by inertial driving parameters generated by an inertial simulation algorithm to provide inertial driving force to the movement of the pedal component and/or the linkage component of the electric bicycle body, so that users can experience the inertial effect of outdoor riding when riding indoors, and improve the user experience of indoor riding. Specifically, the inertial simulation algorithm can generate inertial driving parameters based on the user power curve. The inertial driving parameters comprise the working mode and/or power of the driving component. The working mode comprises a forward assistance mode and a reverse assistance mode. The user power curve can be generated according to the user performance data, and the user performance data is obtained from the sensor module set on the pedal component and/or the wheels.

In a specific implementation, the driving component can be driven by a brushless motor FOC (field-oriented control) driving algorithm. The driving component works in torque mode, and the driving torque can be controlled by controlling the driving phase line current.

Specifically, the driving component can be driven as follows: starting the driving component; controlling the driving component in outdoor riding state (assisted riding mode); judging whether to switch to the indoor exercise state (specifically, whether to switch from the outdoor riding state to the indoor exercise state can be judged by whether the multi-functional electric bicycle is in parking state); if it is not switched to the indoor exercise state, continuing to control the driving component in the outdoor riding state (assisted riding mode); if it is switched to the indoor exercise state, controlling the driving component in the indoor exercise state. In a case where the driving component is controlled in the indoor exercise state, judge whether the pedal frequency data is received from the sensor module; if the pedal frequency data is not received, continue to control the driving component in the indoor exercise state; if the pedal frequency data is received, calculate the transient reverse torque by looking up the table; and reverse the driving component according to the transient reverse torque, so that the driving component can provide the aforementioned inertial driving force.

For the calculation of the transient reverse torque by looking up the table:

First of all, a center axle torque table (center axle torque under different resistance and pedal frequency) is formed according to the pedal frequency of the multi-functional electric bicycle under all working conditions and all torques measured by the resistance. According to the center axle torque table, a rear wheel torque (the rear wheel torque under different resistance and pedal frequency) is calculated according to the linkage ratio of linkage components. According to the linear relationship between torque and phase current, a phase current chart that the rear wheel needs to output under different resistance and pedal frequency is calculated. Based on this phase current chart, based on the resistance and pedal frequency data currently set for the multi-functional electric bicycle, find the pedal frequency data 1 that is closest to and smaller than the current pedal frequency data, the pedal frequency data 2 that is closest to and larger than the current pedal frequency data, the resistance value 1 that is closest to and smaller than the current resistance value, the resistance value 2 that is closest to and greater than the current resistance value, the phase current value 1 under the pedal frequency data 1 and the resistance value 1, the phase current value 2 under the pedal frequency data 1 and the resistance value 2, the phase current value 3 under the pedal frequency data 2 and the resistance value 1, and the phase current value 4 under the pedal frequency data 2 and the resistance value 2. Therefore, based on the pedal frequency data 1, the pedal frequency data 2, the resistance value 1, the resistance value 2, the phase current value 1, the phase current value 2, the phase current value 3, the phase current value 4, combined with the two-point straight line formula (x−x1)/(x2−x1)=(y−y1)/(y2−y1) three times, the phase current value to be sent to the FOC control algorithm is calculated.

First, let x be the current resistance value, x1 be the resistance value 1, x2 be the resistance value 2, y1 be the phase current value 1, and y2 be the phase current value 2 to calculate the pedal frequency data 1 and the phase current value 5 at the current resistance value.

Then, let x be the current resistance value, x1 be the resistance value 1, x2 be the resistance value 2, y1 be the phase current value 3, and y2 be the phase current value 4 to calculate the pedal frequency data 2 and the phase current value 6 at the current resistance value.

Finally, let x be the current pedal frequency data, x1 be the pedal frequency data 1, x2 be the pedal frequency data 2, y1 be the phase current value 5, and y2 be the phase current value 6 to calculate the current pedal frequency data and the phase current value 7 at the current resistance value.

Therefore, the FOC control algorithm can drive the driving component through the calculated phase current value 7.

The above only schematically shows a control mode of a driving component in the present application, and the present application is not limited by this.

The above only schematically shows a number of implementation of the present application, which can be implemented separately or in combination, and the present application is not limited by this.

After considering the specification and practicing the invention disclosed herein, those skilled in the art will easily think of other embodiments of the present invention. The present application is intended to cover any variant, use or adaptive change of the present invention, which follows the general principles of the present invention and comprises the common general knowledge or frequently used technical means in the technical field not disclosed by the present invention. The Description and the embodiments are only regarded as illustrative, and the true scope and spirit of the present invention are indicated by the appended claims.

What is claimed is:

1. A multi-functional electric bicycle comprising:
an electric bicycle body comprising a bicycle frame, a driving component, a linkage component, a pedal component, a sensor module and wheels; and
a support component;
wherein, in a case where the electric bicycle body is supported by the support component, the electric bicycle is in an indoor exercise state, and in a case where the electric bicycle body is supported by the wheels, the electric bicycle is in an outdoor riding state.

2. The multi-functional electric bicycle according to claim 1, wherein, in the case where the electric bicycle is in the indoor exercise state, the driving component provides resistance to movement of the pedal component of the electric bicycle body; in the case where the electric bicycle is in the outdoor riding state, the driving component provides driving force to the movement of the pedal component and/or the linkage component of the electric bicycle body.

3. The multi-functional electric bicycle according to claim 2, wherein, in the case where the electric bicycle is in the indoor exercise state, kinetic energy generated by the movement of the pedal component of the electric bicycle body is converted into electric energy to charge a power unit of the driving component.

4. The multi-functional electric bicycle according to claim 2, wherein, the electric bicycle comprises:
a driving control signal generation module which is configured to:
generate a first signal in response to the electric bicycle being in the indoor exercise state;
generate a second signal in response to the electric bicycle being in the outdoor riding state;
send the first signal or the second signal that are generated to the driving component,
wherein, in a case where the driving component receives the first signal, the driving component provides resistance to the movement of the pedal component of the electric bicycle body, and in a case where the driving component receives the second signal, the driving component provides driving force to the movement of the pedal component and/or the linkage component of the electric bicycle body.

5. The multi-functional electric bicycle according to claim 4, wherein, the driving control signal generation module is further configured to:
in response to user operation, determine the electric bicycle being in the indoor exercise state or the outdoor riding state.

6. The multi-functional electric bicycle according to claim 1, wherein, the sensor module is arranged at one or more positions of the pedal component, the driving component, wheel hubs of the wheels, a saddle arranged on the bicycle frame and handles of the bicycle frame, the sensor module is configured to sense user performance data, the sensor module communicates with a control device, and in the case where the multi-functional electric bicycle is in the indoor exercise state, the control device is configured to receive the user performance data from the sensor module, and process the user performance data through an application program of the control device to provide:
an indoor exercise interaction function and/or an outdoor riding simulation function; and/or
real-time detection of users' movement states, action and postures.

7. The multi-functional electric bicycle according to claim 6, wherein, in a case where the application program of the control device provides the indoor exercise interaction function, the application program is configured to:
receive an exercise guiding video determined according to a selected music input/audio signal or a virtual sports scene constructed by modeling software/engine, wherein, the exercise guiding video comprises a first exercise guiding video and/or a second exercise guiding video, the first exercise guiding video is automatically generated according to the selected music input/audio signal, the second exercise guiding video is a video previously recorded according to the selected music input/audio signal;
play the exercise guiding video or the virtual sports scene constructed by modeling software/engine, and the selected music input/audio signal;
receive the user performance data from the sensor module;
receive display interactive feedback data, wherein, the display interactive feedback data is generated or updated according to a matching between the user performance data and music information of the selected music input/audio signal,
display the display interactive feedback data,
wherein, in a case where the exercise guiding video is played, a CGA (Computer Generated Animation) and special-effect/animated feedbacks are also played.

8. The multi-functional electric bicycle according to claim 7, wherein, the exercise guiding video or the virtual sports scene is generated by:
extracting the music information from the selected music input/audio signal;
matching a movement instruction sequence in a template exercise movement database/inventory, according to the music information and a portrait, or according to a user selection;
generating the exercise guiding video or the virtual sports scene according to the movement instruction sequence.

9. The multi-functional electric bicycle according to claim 8, wherein, the exercise guiding video that is generated is the first exercise guiding video, generating the exercise guiding video according to the movement instruction sequence comprises:
determining an instructor object and generating the first exercise guiding video according to the movement instruction sequence and the instructor object, wherein the instructor object is a virtual instructor or a real instructor; or,
determining a virtual scene/stage, and generating the first exercise guiding video according to the movement instruction sequence and the virtual scene/stage, wherein, the virtual scene/stage has dynamically varying effects corresponding to the movement instruction sequence.

10. The multi-functional electric bicycle according to claim 8, wherein, the exercise guiding video that is generated is the second exercise guiding video, generating the exercise guiding video according to the movement instruction sequence comprises:
generating a movement instruction list according to the movement instruction sequence;
playing the movement instruction list and the selected music input/audio signal;
receiving a pre-determined second exercise guiding video that is recorded, wherein, the pre-determined second exercise guiding video comprises a front layer comprising an instructor object and a recorded CGA, the recorded CGA is a green screen, and the instructor object of the front layer is a real instructor;
extracting the front layer comprising the instructor object from the pre-determined second exercise guiding video as the second exercise guiding video.

11. The multi-functional electric bicycle according to claim 7, wherein, the control device communicates with other control devices to interact in the exercise guiding video or the virtual sports scene based on the user performance data received by each control device.

12. The multi-functional electric bicycle according to claim 6, wherein, the control device communicates with the driving component, and in a case where the application program of the control device provides the outdoor riding simulation function, the application program is configured to:
display a real outdoor scene or a virtual outdoor scene;
generate driving parameters that simulate terrain changes of the outdoor scene;
control the driving component based on the driving parameters.

13. The multi-functional electric bicycle according to claim 12, wherein, a display of the real outdoor scene or the virtual outdoor scene is updated in real time based on the user performance data received from the sensor module.

14. The multi-functional electric bicycle according to claim 12, wherein, the driving component further comprises:
a terrain simulation component which is connected to the multi-functional electric bicycle in a case where the multi-functional electric bicycle is in the indoor riding state to simulate the terrain changes of the outdoor scene.

15. The multi-functional electric bicycle according to claim 6, wherein, the control device is a user intelligent device independent of the multi-functional electric bicycle; or the control device is detachably installed on handle ends of the bicycle frame.

16. The multi-functional electric bicycle according to claim 3, wherein, in the case where the multi-functional electric bicycle is in the outdoor riding state, the control device is configured to generate and display outdoor riding data based on the user performance data received from the sensor module.

17. The multi-functional electric bicycle according to claim 1, wherein, a working mode and/or power of the driving component is determined based on an inertial simulation algorithm, the inertial simulation algorithm generates inertial driving parameters based on the user power curve, and the working mode comprises a forward assistance mode and a reverse assistance mode.

18. The multi-functional electric bicycle according to claim 17, wherein, the driving component provides inertial driving force to movement of the pedal component and/or the linkage component of the electric bicycle body according to the working mode and/or power generated by the inertial simulation algorithm.

19. The multi-functional electric bicycle according to claim 18, wherein the user power curve is generated according to the user performance data, and the user performance data is obtained from the sensor module arranged on the pedal component and/or wheels.

20. The multi-functional electric bicycle according to claim 1, wherein, the support component is a support bracket independent of the electric bicycle body; or the support component is connected to the electric bicycle body in a supporting state or the support component is not connected to the electric bicycle in a non-supporting state.
